(19) United States
(12) Patent Application Publication
(10) Pub. No.: US 2008/0072930 A1
(43) Pub. Date: Mar. 27, 2008

(54) Dishwasher and method of controlling the same

(76) Inventors: Joon Ho Pyo, Seoul (KR); Sang Heon Yoon, Gwangmyung-si (KR); Tae Hee Hee, Boocheon-si (KR)

Correspondence Address: MCKENNA LONG & ALDRIDGE LLP, 1900 K STREET, NW, WASHINGTON, DC, 20006, US

(21) Appl. No.: 11/902,047

(22) Filed: Sep. 18, 2007

(30) Foreign Application Priority Data
Sep. 22, 2006 (KR) 10-2006-0092069

(51) Int. Cl. A47L 15/42; B08B 13/00; B08B 3/04

(52) U.S. Cl. 134/25.2; 134/104.4

(57) ABSTRACT

Provided is an air break, a dishwasher having the air break, and a method of controlling the dishwasher. The dishwasher includes a tub defining a washing chamber, a sump for pumping washing water into the tub, an air break connected to the sump. The sump includes an overflow line, which is formed in the air break and along which the washing water flowing back from the sump flows, and a collecting line for collecting foreign objects contained in the washing water flowing back from the overflow line.

This application claims the benefit of Korean Patent Application No. 10-2006-0092069, filed on Sep. 22, 2006, which is hereby incorporated by reference for all purposes as if fully set forth herein.

### BACKGROUND OF THE INVENTION

1. Field of the Invention

The present invention relates to a dishwasher and, more particularly, to a dishwasher having an air break that includes a collecting line for collecting foreign objects, such as food waste, and a method of controlling the dishwasher.

2. Discussion of the Related Art

Generally, a dishwasher is a home appliance that washes dishes by spraying water at high pressure onto the surfaces of dishware. A dishwasher may also dry the dishware.

A typical dishwasher includes a tub defining a washing chamber and a sump that is mounted on the bottom of the tub to store washing water. The washing water is directed to spray nozzles by a pumping operation of a washing pump mounted in the sump. The washing water directed to the spray nozzles is sprayed at a high pressure through spray holes formed on the ends or surfaces of the spray nozzles. The washing water sprayed at a high pressure collides with the surfaces of the dishes and thereby removes food waste adhered to the surfaces. The removed food waste falls down to the bottom of the tub.

Most of the washing water pumped by the washing pump is sprayed through the spray nozzles and the remainder of the washing water is used to remove the foreign objects, including the food waste, in a filtering unit. If foreign object clog the mesh of the filtering unit, pressure is generated in the filtering unit; the pressure may be excessive.

When the filtering unit is blocked by foreign objects, then the filtering performance of the filtering unit deteriorates and foreign objects may be circulated and introduced into the washing chamber of the tub. Moreover, the foreign objects introduced into the tub may adhere to the dishes, thereby deteriorating the washing performance of the dishwasher.

### SUMMARY OF THE INVENTION

Accordingly, the present invention is directed to a dishwasher and method of controlling the same that substantially obviates one or more of the problems due to limitations and disadvantages of the related art.

An advantage of the present invention is to provide a tub defining a washing chamber, a sump for pumping water into the tub; and an air break connected to the sump. The air break may include further comprising an overflow line to transport the water from the sump and a collecting line for collecting foreign objects contained in the water flowing in the overflow line.

Another advantage of the present invention is to provide a method of controlling a dishwasher, where the method may include collecting foreign objects introduced from a sump in a collecting line, draining water by operating a drain pump, and supplying water to the collecting line through a water supply line to discharge the foreign objects out of the collecting line.

Additional features and advantages of the invention will be set forth in the description which follows or may be learned by practice of the invention. The features and other advantages of the invention may be realized and attained by the structure and method particularly pointed out in the written description and claims hereof as well as in the appended drawings.

To achieve these and other advantages and in accordance with the purpose of the present invention, as embodied and broadly described herein, according to one embodiment there is provided, a dishwasher including: a tub defining a washing chamber; a sump to hold washing water for pumping of the washing water into the tub; an air break connected to the sump; an overflow line formed in the air break and through which washing water flowing back from the sump may flow; and a collecting line for collecting foreign objects contained in the water flowing back from the overflow line.

In another embodiment of the present invention, there is provided an air break for a dishwasher, including: a water supply line for supplying washing water; an overflow line along which the washing water flowing back from a sump flows; a flow reduction wall upon which the washing water flowing along the overflow line collides; a collecting line for collecting the foreign objects contained in the washing water colliding with the flow reduction wall; and a backflow preventing line for preventing the foreign objects collected in the collecting line from being introduced into the water supply line.

In still another embodiment of the present invention, there is provided a method of controlling a dishwasher, including: collecting foreign objects introduced from a sump in a collecting line; draining water by operating a drain pump; and supplying water to the collecting line through a water supply line to discharge the foreign objects out of the collecting line.

According to the present invention, the foreign objects (food waste) flowing back into the collecting line of the air break can be collected. Therefore, when the filter of the sump is blocked, an amount of the foreign objects introduced into the tub can be significantly reduced.

In addition, since the water supply to the air break is realized during a drain cycle of the dishwasher, the foreign objects collected in the collecting line can be immediately discharged from the dishwasher.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic side sectional view of a dishwasher according to an embodiment of the present invention;

FIG. 2 is a side sectional view of a dishwasher to which an air break according to an embodiment of the present invention is applied;

FIG. 3 is a schematic view of an air break according to an embodiment of the present invention;

FIG. 4 is a schematic view illustrating a foreign object collection process in an air break according to an embodiment of the present invention;

FIG. 5 is a schematic view illustrating a foreign object discharge process from an air break according to an embodiment of the present invention;

FIG. 6 is a view illustrating a method for discharging foreign objects collected in an air break according to an embodiment of the present invention; and

FIG. 7 is a view illustrating a method for discharging foreign objects collected in an air break according to an embodiment of the present invention.

### DETAILED DESCRIPTION OF THE ILLUSTRATED EMBODIMENTS

Reference will now be made in detail to an embodiment of the present invention, an example of which is illustrated in the accompanying drawings.

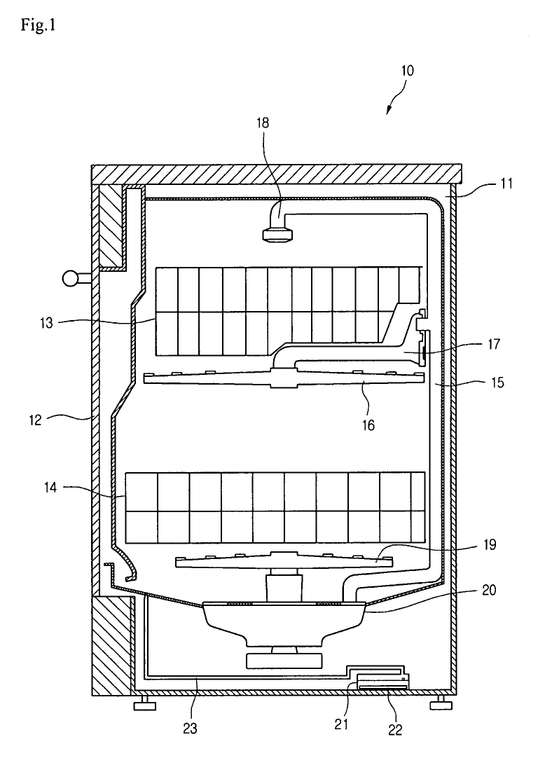

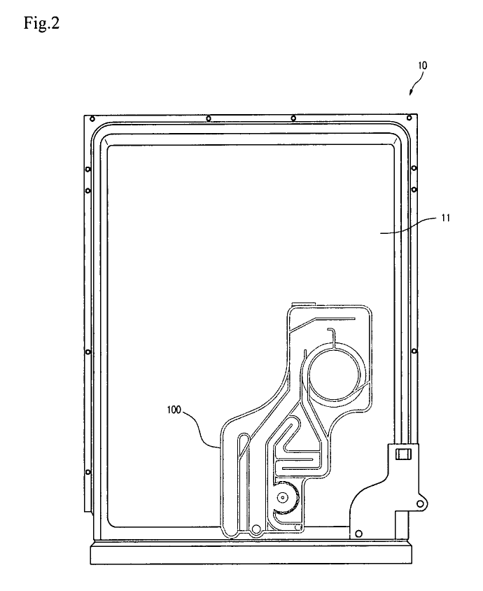

FIG. 1 is a schematic side sectional view of a dishwasher 10 according to an embodiment of the present invention. FIG. 2 is a side sectional view of the dishwasher 10 to which an air break 100 according to an embodiment of the present invention is applied. The invention may, however, be embodied in many different forms and should not be construed as being limited to the embodiments set forth herein; rather, these embodiments are provided so that this disclosure will be thorough and complete, and will fully convey the concept of the invention to those skilled in the art.

Referring to FIGS. 1 and 2, the dishwasher 10 includes a tub 11 defining a washing chamber, a door 12 pivotally installed on a front portion of the tub 11, a sump 20 that is installed on a bottom of the tub 11 to hold and pump out washing water, a water guide 15 that guides the water pumped from the sump 20, spray nozzles 16, 18, and 19 for spraying the washing water into the washing chamber, and dish racks 13 and 14 on which the dishes are loaded.

The dishwasher 10 further includes an air break 100 mounted on an outer surface of the tub 11 to direct the washing water from a water supply unit (not shown) to the sump 20. The air break 100 is provided with a water supply control unit, and a steam generating unit 21 that is provided under the tub 11 to supply steam into the washing chamber of the tub 11.

The dish racks include an upper rack 13 provided on an upper portion of the tub 11 and a lower rack 14 provided under the upper rack 13. The upper and lower racks 13 and 14 are installed to be capable of being removed from of the tub 11. To realize this removal, rails (not shown) or rail rollers (not shown) may be formed on the tub 11.

The water guide 15 may be provided in a vertical alignment on an inner-rear surface of the tub 11 adjacent to an external side. Opposite ends of the water guide 15 may be bent such that an overall shape of the water guide 15 becomes a C-shape. The water guide 15 is connected to the sump 20 to allow the washing water pumped out from the sump 20 to flow toward the spray nozzles 16 and 18.

In addition, the lower nozzle 19 is mounted on a central portion of the sump 20 to spray the washing water upward toward the lower rack 14. The upper nozzle 16 is provided under the upper rack 13 to spray the washing water upward toward upper rack 13 and downward toward the lower rack 14. The top nozzle 18 is coupled to the upper end of the water guide 15 to spray the washing water downward. The upper nozzle 16 is connected to the water guide 15 by a nozzle holder 17 that extends from the upper nozzle 16 and is mounted on the front portion of the water guide 15, thereby receiving the washing water from the water guide 15.

The steam generating unit 21 is designed to supply steam to the washing chamber of the tub 11 using a heater 22 that heats the water supplied from the air break 100. A steam supply passage 23 is connected to the steam generating unit 21 to supply the steam generated in the steam generating unit 21 to the washing chamber of the tub 11.

Describing the operation of the dishwasher 10 when the dishwasher starts operating, the washing water is supplied into the sump 20 via water supply line 170 of the air break 100. When the washing water supplied to the sump 20 reaches a predetermined water level, a washing motor (not shown) operates to pump out the washing water. The washing water pumped out by the washing motor is alternately directed to the water guide 15 and the lower nozzle 19.

A portion of the washing water flowing along the water guide 1S is directed to the upper nozzle 16 along the nozzle holder 17 and the remaining washing water is directed to the top nozzle 18. In the washing chamber of the tub 1, the washing water is sprayed through the lower nozzle 19 for a predetermined time and subsequently the washing water is sprayed through the upper nozzle 16 and top nozzle 18. This is repeated to perform the washing cycle.

The washing water directed to the upper, top, and lower nozzles 16, 18, and 19 is sprayed into the washing chamber of the tub 11 through spraying holes formed on the nozzles 16, 18 and 19. The washing water is sprayed at a high pressure from the spraying holes and as a result, the food residue adhered to the dishes loaded on the upper and/or lower racks 13 and/or 14 are removed from the dishes.

During the above-described operation of the dishwasher 10, steam generated in the steam generating unit 21 is supplied into the tub 11 for a predetermined period. That is, when the washing water is fed to the steam generating unit 21 from the air break 100, the washing water is heated by the heater 22 and phase changed into steam. The steam is supplied into the washing chamber of the tub 11 via the steam supply passage 23.

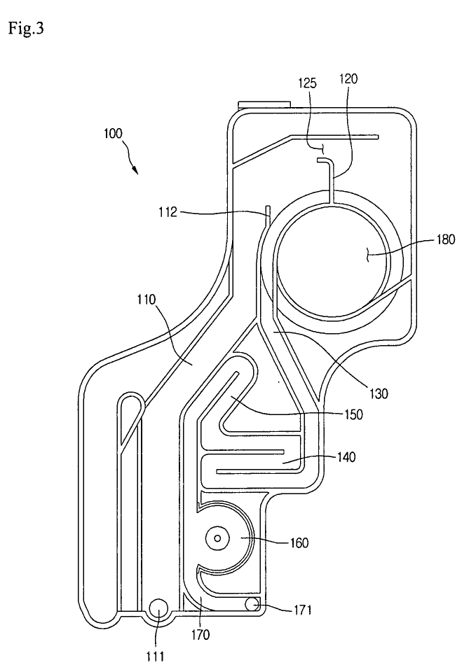

FIG. 3 is a schematic view of the air break 100 according to an embodiment of the present invention.

Referring to FIG. 3, the air break 100, according to an embodiment of the present invention, includes an overflow line 110, a flow reduction wall 120, a tub guide passage 125, a foreign object falling line 130, a collecting line 140, a backflow preventing line 150, a flow meter 160, a water supply line 170, and a tub communication hole 180.

The overflow line 110 is a passage along which the water supplied to the sump 20 from the water supply line 170 flows. The overflow line 110 also functions as a backflow passage along which the foreign objects introduced together with the washing water from the sump 20 flows.

A sump communication hole 111 is formed in a lower end of the overflow line 110. The sump communication hole 111 allows the overflow line 110 to connect with the sump 20. The washing water can be fed to the sump 20 through the sump communication hole 111 and the foreign objects introduced from the sump 20 can flow back to the overflow line 110.

The flow reduction wall 120 having a predetermined height may be formed at an upper end of the overflow line 110. A portion of the washing water flowing along the overflow line 110 and the foreign objects contained in the washing water are caught by the flow reduction wall 120. As the foreign objects are caught by the flow reduction wall 120, an amount of the foreign objects flowing back into the tub 11 through the tub communication hole 180 can be reduced.

In this embodiment, the flow reduction wall 120 is bent toward the overflow line 110 to increase an amount of the foreign objects caught by the flow reduction wall 120.

The foreign object falling line 130 is formed below the flow reduction wall 120. The foreign object falling line 130 is a passage along which the washing water and the foreign objects that are caught by the flow reduction wall 120 fall down. The foreign object falling line 130 is formed in a direction so that the foreign objects fall down by the force of gravity. The location of the flow reduction wall 120 is not limited to a specific location. That is, as far as the flow reduction wall 120 can catch the foreign objects and the washing water that flow back, the flow reduction wall 120 can be installed anywhere. In one embodiment, the flow reduction wall 120 may be formed extending from a barrier rib defining the foreign object falling line 130.

A barrier rib 112 may be formed between the foreign object falling line 130 and the overflow line 110. A height of the barrier rib 112 may be lower than that of the flow reduction wall 120. The barrier rib 112 functions to guide the backflow of the foreign objects from the overflow line 110 to the foreign object falling line 130.

Meanwhile, the collecting line 140 is formed on an end of the foreign object falling line 130. The collecting line 140 functions to collect the foreign objects falling along the foreign object falling line 130. By forming the collecting line 140, the foreign objects can be collected therein.

In the present embodiment, the collecting line 140 is formed in a zigzag shape or meander shape, which has the effect of increasing the collecting space, for a given length, wherein an amount of the foreign objects may be collected. Furthermore, in order to store the collected foreign objects, it is desirable that the collecting line 140 is formed in a direction opposite to the effect of gravity (e.g., a horizontal direction). In addition, the backflow preventing line 150 is formed at an end portion of the collecting line 140. The backflow preventing line 150 functions to prevent the foreign objects collected in the collecting line 140 from being introduced into the water supply line 170.

The backflow preventing line 150 is inclined toward the collection line 140, in order to prevent foreign objects collected in the collecting line 140 from flowing back into the water supply line 170.

A first end of the water supply line 170 is connected to an end of the backflow preventing line 150. The water supply line 170 is provided at a second end with a water supply hole 171. The water supply hole 171 is connected to an external water supply unit (not shown) by a water supply hose (not shown).

The flow meter 160 is installed on the water supply line 170 to detect an amount of the water supplied from the external water supply unit along the water supply line 170.

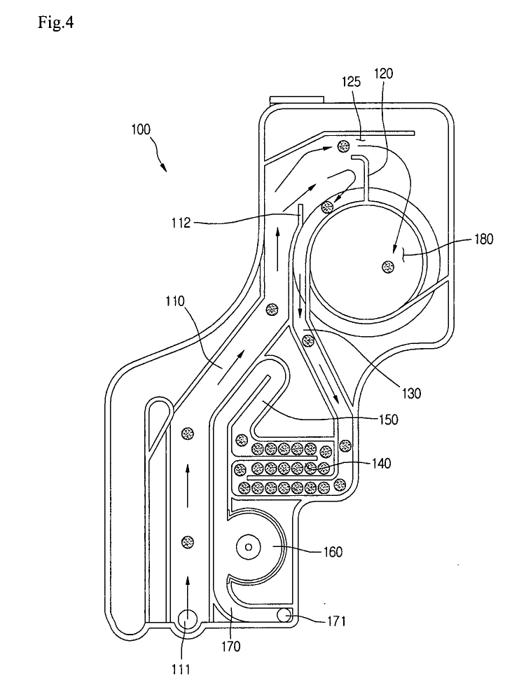

FIG. 4 is a schematic view illustrating the collection of foreign objects in the air break 100.

Referring to FIG. 4, when the filter (not shown) of the sump 20 is blocked by the foreign objects, the washing water together with the foreign objects are introduced into the air break 100 through the sump connection hole 111.

The washing water and the foreign objects introduced into the air break 100 flows back along the overflow line 110. A portion of the washing water containing the foreign objects is blocked by the flow reduction wall 120. The remaining washing water flows over the flow reduction wall 120 and thus to the tub 11 through the tub communication hole 180.

The foreign objects caught by the flow reduction wall 120 fall down by the effect of gravity along the foreign object falling line 130 and are collected in the collection line 140. Because the backflow preventing line 150 is bent toward the collecting line 140, the foreign objects are prevented from being introduced from the collecting line 140 into the water supply line 170.

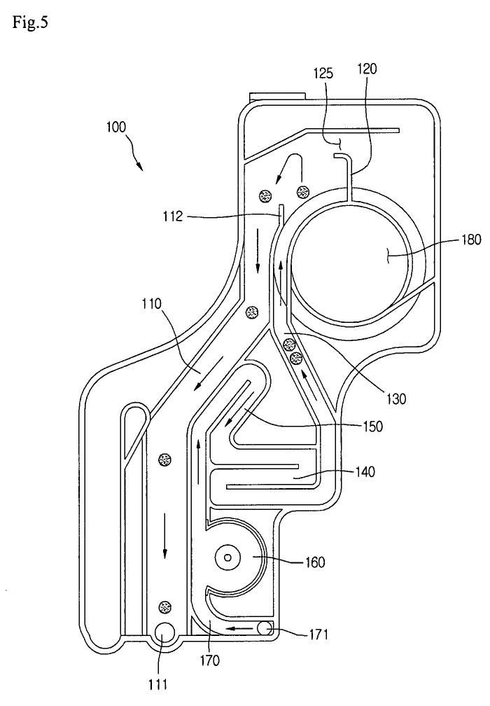

FIG. 5 is a schematic view illustrating a foreign object discharge process from the air break 100 according to an embodiment of the present invention.

Referring to FIG. 5, in a state where the foreign objects are collected in the collecting line 140, water is supplied from the water supply line 170 through the water supply hole 171. The supplied water discharges the foreign objects out of the collecting line 140.

The water supplied from the water supply line 170 is mixed with the foreign objects in the collecting line 140 and ascends together with the foreign objects along the foreign object falling line 130. Since the height of the barrier rib 112 between the overflow line 110 and the foreign object falling line 130 is lower than that of the flow reduction wall 120, the ascended water mixed with the foreign objects is introduced into the overflow line 110.

The water mixed with the foreign objects and introduced into the overflow line 110 is directed to the sump 20 through the sump communication hole 111.

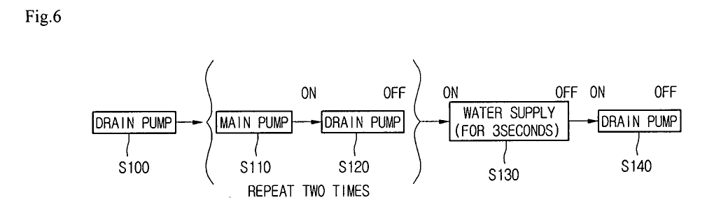

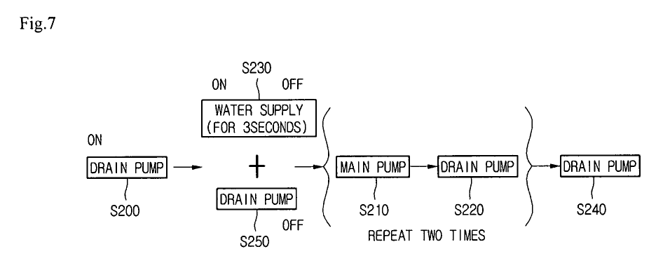

FIGS. 6 and 7 are views illustrating a method for discharging foreign objects collected in the collecting line 140 of the air break 100 according to an embodiment of the present invention.

When the foreign objects introduced from the sump are collected in the collecting line 140, a drain pump operates and the water is supplied to the collecting line 140 through the water supply line 170. When the water is supplied to the collecting line 140 from the water supply line 170, the foreign objects collected in the collecting line 140 are directed to the sump 20 and consequently the drain pump operates to discharge the foreign objects from the sump 20 (and from the dishwashing machine 10).

Referring first to FIG. 6, the drain cycle starts and thus the drain pump operates (S100). The main pump is turned on (S110) and the drain pump is turned off (S120). Steps (S110 and S120) are repeated.

The drain pump is turned off at the end of the drain cycle (S120) and water is supplied through the water supply line 170 from the water supply hole 171 for a predetermined time (for example, 3 seconds) (S130). During the supplying of water in step S130, foreign objects may be flushed from the collecting line 140 and introduced into the sump 20 as shown in FIG. 5. At this point, the drain pump becomes operable (S140) to discharge the foreign objects from the dishwashing machine 10 and the drain pump turns off (S140).

Here, the water supply step (S130) is performed before the drain pump operates again (S140) and after the drain pump is turned off (S120). However, the present invention is not limited to this methodology. For example, the water supply step (S130) may be performed between the operation of the drain pump (S100) and before the operation of the main pump (S110) or between the operation of the main pump (S110) and the operation of the drain pump (S100).

Referring to FIG. 7, the drain pump is turned on (S200), the water is supplied to the tub 11 for a predetermined amount of time, during the operation of drain pump (S230). Subsequently, the operation of the main pump (S210) and the operation of the drain pump (S220) are repeated and the re-operation of the drain pump (S240) may be realized. Through this process, the foreign objects collected in the collecting line 140 are discharged to an external side.

Although the water supply step (S230) is performed together with the operation of the drain pump (S250), the present invention is not limited to this configuration. For example, the water supply step (S230) may be performed together with the initial operation of the drain pump (S200), the operation of the drain pump (S220) in the repeated cycle, or the re-operation of the drain pump (S240).

Meanwhile, the foreign objects introduced into the sump 20 are not directed to other portions of the sump 20 by a check valve (not shown) but are directly discharged from the dishwashing machine 10 through the drain line (not shown).

According to the present invention, the foreign objects (food waste) flowing back into the collecting line 140 of the air break 100 can be collected. Therefore, when the filter of the sump 20 is blocked, an amount of the foreign objects introduced into the washing chamber of the tub 11 can be significantly reduced.

In addition, since water is supplied to the collecting line 140 during a drain cycle of the dishwasher 10, the foreign objects collected in the collecting line can be immediately discharged to the sump 20 and out of the dishwasher 10.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A dishwasher comprising:
a tub defining a washing chamber;
a sump for pumping water into the tub; and
an air break connected to the sump, further comprising;
an overflow line to transport the water from the sump; and
a collecting line for collecting foreign objects contained in the water flowing in the overflow line.

2. The dishwasher according to claim 1, further comprising a flow reduction wall extending into the overflow line, such that the water and foreign objects flowing in the overflow line collide with the flow reduction wall prior to entering the collecting line.

3. The dishwasher according to claim 2, wherein the flow reduction wall is bent toward the overflow line.

4. The dishwasher according to claim 2, further comprising a foreign object falling line along which the foreign objects caught by the flow reduction wall fall down to the collecting line.

5. The dishwasher according to claim 4, wherein the foreign object falling line connects the overflow line to the collecting line.

6. The dishwasher according to claim 4, wherein a height of a barrier wall between the foreign object falling line and the overflow line is lower than that of the flow reduction wall.

7. The dishwasher according to claim 1, further comprising a foreign object falling line for directing the foreign objects from the overflow line to the collecting line.

8. The dishwasher according to claim 6, wherein the foreign object falling line connects the overflow line to the collecting line.

9. The dishwasher according to claim 1, wherein the collecting line is formed in a zigzag shape or a meander shape.

10. The dishwasher according to claim 1, further comprising a water supply line for supplying the washing water from an external water source to the collecting line.

11. The dishwasher according to claim 1, further comprising a backflow preventing line for preventing the foreign objects in the collecting line from flowing back into a water supply line.

12. The dishwasher according to claim 11, wherein the backflow preventing line is inclined toward the collecting line.

13. An air break for a dishwasher, comprising:
a water supply line for supplying washing water;
an overflow line transporting washing water flowing from a sump;
a flow reduction wall that contacts the washing water flowing in the overflow line;
a collecting line for collecting the foreign objects contained in the washing water that collide with the flow reduction wall; and
a backflow preventing line for preventing the foreign objects collected in the collecting line from being introduced into the water supply line.

14. The air break according to claim 13, further comprising a foreign object falling line for directing the foreign objects colliding with the flow reduction wall to the collecting line.

15. The air break according to claim 13, wherein the backflow preventing line is formed above the collecting line.

16. A method of controlling a dishwasher, comprising:
collecting foreign objects introduced from a sump in a collecting line;
draining water by operating a drain pump; and
supplying water to the collecting line through a water supply line to discharge the foreign objects out of the collecting line.

17. The method according to claim 16, wherein the water is supplied while the drain pump is operating.

18. The method according to claim 16, wherein the water is supplied before the drain pump operates.

19. The method according to claim 16, wherein the water is supplied after the drain pump operates.

20. The method according to claim 16, wherein the water is supplied simultaneously with the operation of the drain pump.

21. The method according to claim 16, wherein supplying water includes directing the foreign objects to the sump and re-operating the drain pump to discharge the foreign objects from the dishwasher.
